(19) United States
(12) Patent Application Publication
(10) Pub. No.: US 2009/0125369 A1
(43) Pub. Date: May 14, 2009

(54) SYSTEM AND METHOD FOR ANALYZING AND DISPOSITIONING MONEY LAUNDERING SUSPICIOUS ACTIVITY ALERTS

(75) Inventors: Brian James Kloostra, Wyoming, MI (US); Chaitanya Dalvi, Hoffman Estates, IL (US); Brookton Noah Behm, Grand Rapids, MI (US)

Correspondence Address: BARNES & THORNBURG LLP, 600 ONE SUMMIT SQUARE, FORT WAYNE, IN, 46802, US

(73) Assignee: Crowe Horwath LLP, Oak Brook, IL (US)

(21) Appl. No.: 12/258,784

(22) Filed: Oct. 27, 2008

Related U.S. Application Data
(60) Provisional application No. 60/982,783, filed on Oct. 26, 2007.

(51) Int. Cl. G06Q 10/00; G06Q 40/00

(52) U.S. Cl. 705/9; 705/30

(57) ABSTRACT

A system and method for analyzing, dispositioning, recording, reviewing, and managing potentially suspicious financial transactions. In some cases, the system models the steps taken by a subject matter expert to reach a conclusion so that a novice can follow similar steps and have the system generate a narrative of the steps taken and the conclusion that was reached.

### RELATED APPLICATIONS

This application claims priority to U.S. Provisional Application No. 60/982,783, filed Oct. 26, 2007, the entire disclosure of which is hereby incorporated by reference.

### TECHNICAL FIELD

This disclosure relates generally to a system and method for analyzing, dispositioning, recording, reviewing and managing money laundering and terror financing suspicious activity alerts.

### BACKGROUND

A key strategy in America's war on terrorism and crime is the elimination of terrorists' and criminals financial supply lines. Financial institutions play a critical role in this effort by analyzing transactions for suspicious activities. Indeed, the Bank Secrecy Act (“BSA”) currently requires financial institutions to monitor customer behavior, maintain records of certain types of transactions, and file reports with the government. Required reports include suspicious transaction reports (“STRs”) describing activities perceived by the financial institution to be suspicious or out of the ordinary from a customer's usual pattern of activity or where the customer seems to be trying to avoid BSA reporting requirements. Financial institutions are incurring significant costs to review and analyze alerts that are generated by their transaction monitoring systems. The current process is very expensive because it is labor intensive. Each investigation is conducted by an individual analyst who applies subjective criteria to determine if the alert detected potentially suspicious activity. Because of the subjectivity, significant review and quality control is needed, thus increasing the labor content even more. Every financial institution is facing huge increases in the number of internal or external resources needed to resolve these potentially suspicious alerts.

At the same time, institutions are facing increasing pressure from regulators to better document the decision making process, improve the quality of the narrative and institute traceable management review. The documentation of the decision making process requires that the review of potentially suspicious activity be standardized and follow agreed upon criteria that management has approved. Expectations of the narrative summary are that an examiner can, without having to go to external systems of record, understand the reason the activity was flagged as unusual, the steps taken to investigate the unusual activity, and the justification for the conclusion that was reached. Increased expectations for quality control require management to be diligent in ensuring that all alerts, even those dispositioned as not suspicious, have some level of oversight by the institution.

Therefore, there is a need for a system that increases efficiency in reviewing alerts, while simultaneously increasing the quality of the review and corresponding management of the process.

### SUMMARY

According to one aspect, the disclosure provides a system and method for analyzing, dispositioning, recording, reviewing, and managing potentially suspicious financial transactions. More generally, this disclosure provides a system for modeling the steps taken by a subject matter expert to reach a conclusion so that a novice can follow similar steps and have the system generate a narrative of the steps taken and the conclusion that was reached.

The system provides an organization with the ability to direct and manage the desired review process through a tool that minimizes (or could eliminate) custom programming. The system will allow a business user to model the organization's population of suspicious activity alerts and how the organization would prefer to review and escalate each of these alert types, and how those modeled activities will be described in a natural language narrative. It also provides a configurable quality control capability to review the work done by each analyst and a configurable dashboard and reporting capability for analysis of productivity and results.

Typically, alerts are reviewed using predetermined business rules based on a particular profile and/or class of alert. These alerts may come from a variety of sources including, but not limited to, transaction monitoring systems, fraud detection systems, Customer Due Diligence (CDD) exceptions or manual call-ins from a customer facing representative. For example, an analyst may be provided with step-by-step instructions for gathering information necessary to determine whether further investigation is warranted. Upon gathering this information, the system may be configured to automatically generate a grammatical narrative describing the gathered information. If further investigation is not necessary, the analyst may send the disposition and automatically generated alert narrative to the organization's system of record which may be, for example, a transaction monitoring system or an external case management system. Alternatively, the analyst may escalate the alert, along with the automatically generated narrative, to an investigator for purposes of an investigation and determining whether or not a Suspicious Activity Report (“SAR”) should be filed. Additional features and advantages of the disclosure will become apparent to those skilled in the art upon consideration of the following detailed description of the illustrated embodiment exemplifying modes of carrying out the disclosure as presently perceived. It is intended that all such additional features and advantages be included with this description and be within the scope of the invention.

### BRIEF DESCRIPTION OF THE DRAWINGS

The present disclosure will be described hereinafter with reference to the attached drawings which are given as non-limiting examples only, in which:

FIG. 1 is a block diagram of an example Anti-Money Laundering (AML) Financial Intelligence Unit (FIU) process flow illustrating possible operations that could occur when monitoring activities;

FIG. 2 is a block diagram of an example alert review system;

FIG. 3 is an example Alert Queue Engine illustrating how alerts could be entered into the system, prioritized and assigned to pre-queues and analyst work queues in one embodiment;

FIG. 4 is an example Alert Review Module illustrating how a single starting alert review block could determine the dynamic activity review flow having review steps and associated response sets;

FIG. 5 is an example Narrative Engine illustrating how system variables could be combined with static text and responses to generate a narrative summary in one embodiment;

FIG. 6 is a flow chart showing example steps that may be taken by an analyst using the alert review system;

FIG. 7 shows an example interface that may be used to select an alert to review from a queue;

FIG. 8 shows an example interface that displays information from the imported alert;

FIG. 9 shows an example interface that may be used to gather information to determine whether an investigation is warranted;

FIG. 10 is an example of an automatically generated alert narrative;

FIG. 11 is an example interface that may be used to indicate the disposition of an alert after an analyst has reviewed the alert; and

FIG. 12 is an example interface for determining performance analysis and possibly other process flow characteristics.

FIG. 13 is an example of alert narrative statements generated through the Narrative Engine based on an example narrative formula and example responses.

The exemplification set out herein illustrates embodiments of the disclosure that is not to be construed as limiting the scope of the disclosure in any manner. Additional features of the present disclosure will become apparent to those skilled in the art upon consideration of the following detailed description of illustrative embodiments and exemplifying modes of carrying out the disclosure as presently perceived.

### DETAILED DESCRIPTION

While the present disclosure may be susceptible to embodiment in different forms, there is shown in the drawings, and herein will be described in detail, embodiments with the understanding that the present description is to be considered an exemplification of the principles of the disclosure and is not intended to be exhaustive or to limit the disclosure to the details of construction and the arrangements of components set forth in the following description or illustrated in the drawings.

As should be appreciated by one skilled in the art, the present disclosure may be embodied in many different forms, such as one or more devices, methods, data processing systems, or program products. Accordingly, the embodiments may take the form of an entirely software embodiment or an embodiment combining hardware and software aspects. Furthermore, embodiments may take the form of a computer program product on a computer-readable storage medium having computer-readable program code embodiment in the storage medium. Any suitable storage medium may be utilized, including read-only memory (“ROM”), random access memory (“RAM”), dynamic random access memory (“DRAM”), synchronous dynamic random access memory (“SDRAM”), hard disk(s), CD-Rom(s), DVD-ROM(s), any optical storage device, and any magnetic storage device.

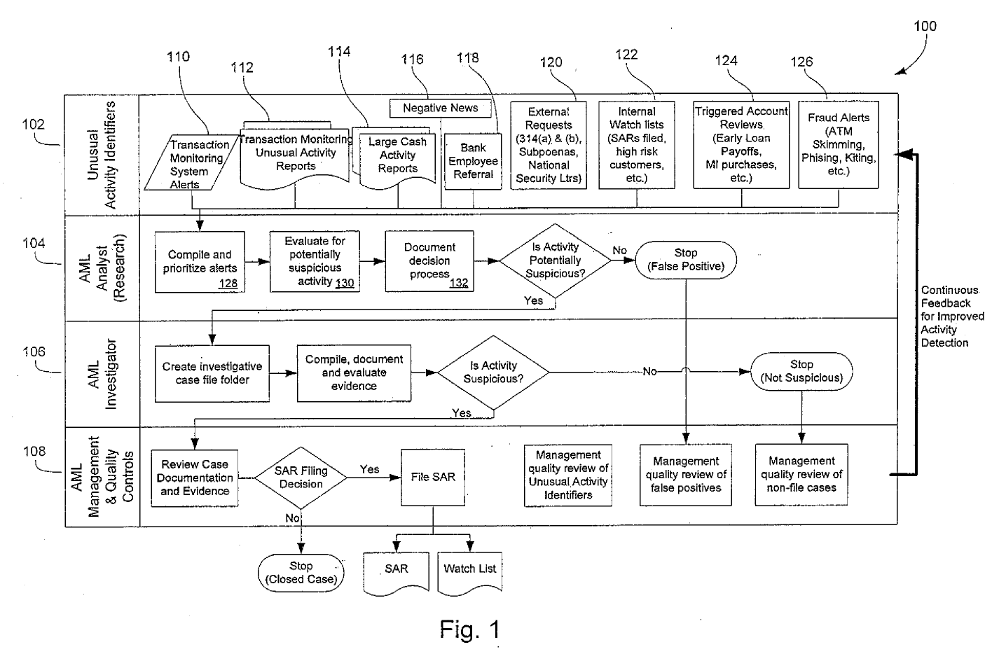

FIG. 1 shows an example Financial Intelligence Unit (FIU) process 100 with steps that a regulated financial services company could follow for identifying, prioritizing, analyzing, dispositioning, recording, reviewing and managing money laundering and terror financing suspicious activity alerts. In the example shown, there are four overarching functions (i.e., roles) that can be performed by computing systems or people (or a combination of people and computing systems). This example includes unusual activity identifier 102, AML analyst(s) 104, AML investigator(s) 106, and AML management and quality controls 108.

Unusual activity identifiers 102 are typically systems or processes that identify customer or account activity that is potentially unusual based on that system's or process' definition of an unusual activity. Unusual activity identifiers 102 serve as the primary input for the AML Analyst 104 who must compile and prioritize alerts, evaluate alerts for unusual activity to determine if in fact the potentially unusual alerts are unusual, document the decision process and make the decision on whether the activity is unusual. Possible unusual activity identifiers 102 could include, but is not limited to, transaction monitoring system alerts 110, transaction monitoring unusual activity reports 112, large cash activity reports 114, negative news 116, bank employee referral 118, external requests 120, internal watch lists 122, triggered account reviews 124, and fraud alerts 126.

The unusual activity identifiers 102 are provided to the AML analyst 104 who must determine that the alert is either not suspicious and dismiss it, or, determine the alert is potentially suspicious and escalate the alert to an AML Investigator 106. For example, the AML analyst could compile and prioritize alerts (128), evaluate for potentially suspicious activity (130), and go through a document decision process (132) to evaluate the alerts.

The AML Investigator 106 performs an investigation and if the activity is suspicious, creates a Suspicious Transaction Report (STR) [called a Suspicious Activity Report (SAR) in The United States of America] which is then approved by AML Management and Quality Control 108. The division of responsibilities between the AML analyst 104 and the AML investigator 106 results in a two-step process for reviewing and investigating alerts. Embodiments using this two-step approach, with an analyst and investigator, lower costs of the review, provide efficiencies.

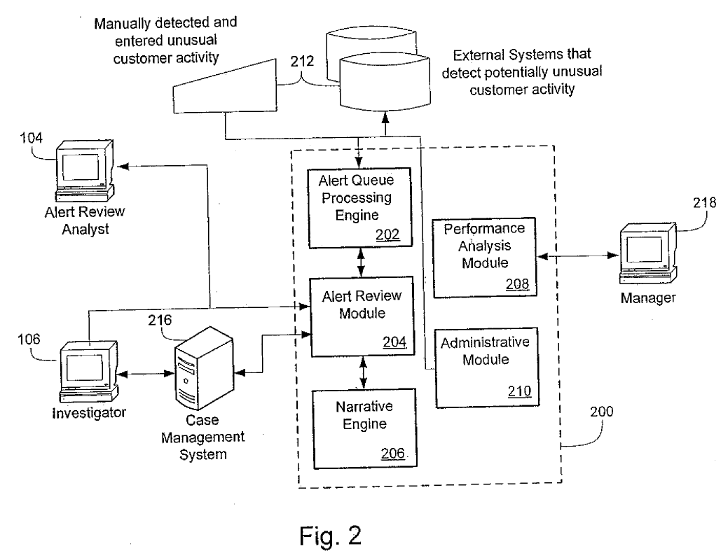

FIG. 2 shows an example alerts review system (“ARS”) 200 in accordance with one illustrative embodiment that may be used to manage, review, analyze and dispose of alerts regarding potentially suspicious financial transactions. In the embodiment shown, the ARS 200 includes an alert queue processing engine 202, an alert review module 204, a narrative engine 206, a performance analysis module 208 and an administrative module 210. Although each of these components 202, 204, 206, 208, and 210 is represented by a single block in FIG. 1 for purposes of example, the operation of each of these components 202, 204, 206, 208, and 210 may be distributed among a plurality of computing devices. For example, it should be appreciated that various subsystems (or portions of subsystems) of the ARS 200 may communicate over a network.

A plurality of alerts 212 may be provided to the system. For example, the alerts 212 may be imported or entered into the ARS 200. The alerts 212 comprise information regarding potentially suspicious financial transactions which are typically generated by transaction monitoring systems or various other sources of unusual activity identifiers 102. For example, the transaction monitoring systems may include software configured to detect potentially suspicious transactions. For another example, the potentially unusual activity may take the form of a bank teller telephonically reporting an unusual activity based on an observation. Using the administrative module 210, a user can configure definitions for the various unusual activity identifiers 102 that provide alerts to the ARS with alerts. This data model allows the ARS to use the specific data fields being sent by the unusual activity identifiers 102 (such as Total Transaction Amount, Total Wire Count, etc.) throughout the ARS. This structure provides the ability to support any type of unusual activity identifier 102 and this model can easily be extended to other types of activity as well. Based on the configurable definitions that are defined, the import process automatically detects which data model to use when importing alerts.

The administrative module 210 contains an Activity Generation Wizard (“AGW”) that allows a user to apply rules and logic against a set of data in order to produce new activity for review. These alerts are treated in the same manner as alerts generated from external unusual activity identifiers 102.

One or more users (or systems) may be in communication with the ARS 200. By way of example only, users may communicate with the ARS 200 using a web browser, such as Internet Explorer by Microsoft Corporation of Redmond, Washington. The browser may be viewed on any computing device, including but not limited to a personal computer, work station, or personal digital assistant (“PDA”). In the example shown, one or more analysts 104 may communicate with the ARS 200 to perform research to determine whether an investigation should be conducted, as discussed below. The example in FIG. 2 also shows one or more investigators 106 in communication with the ARS 200 either directly or via a Case Management System 216 regarding whether a SAR is to be filed. This example also shows an external system (such as a transaction monitoring system) 212 in communication with the ARS 200 for both importing of alerts that need to be dispositioned and exporting of alert status.

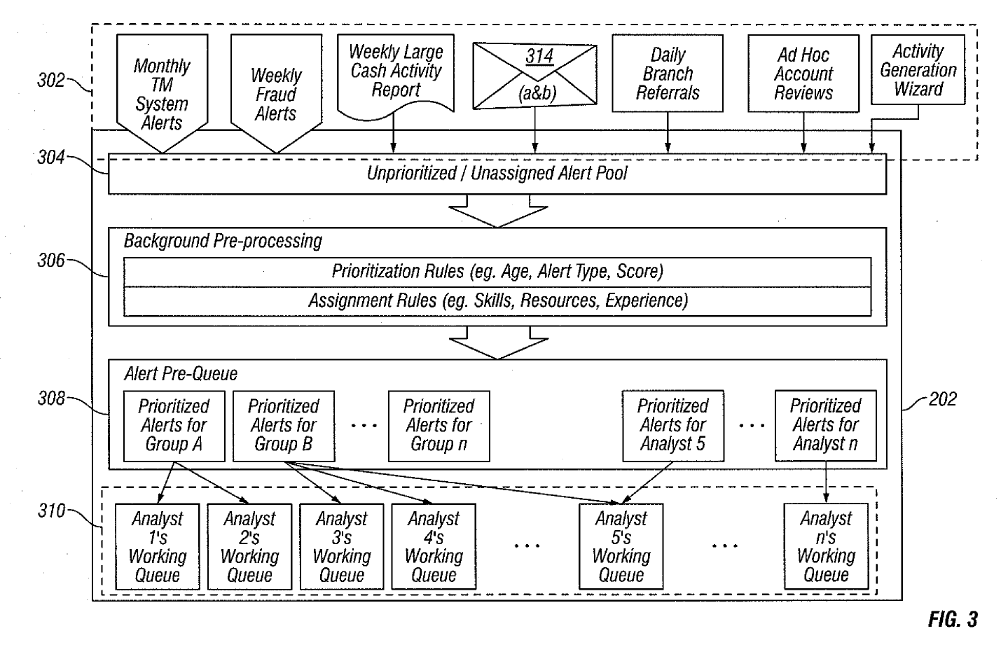

FIG. 3 shows an example alert queue engine which is one component of the ARS 200.

The alert queue processing engine 202 may be configured to manage the import, prioritization and assignment of alerts needing review. A plurality of alert sources 302 may be configured to pass potentially suspicious customer activity notifications to the unprioritized/unassigned alert pool 304 in the alert queue processing engine 202. Rules to prioritize the order in which alerts are worked and who should be assigned to work the alerts can be configured using the administrative module 210. A background pre-processing routine 306 can be configured to run either at specified times or whenever alerts are added to the unprioritized/unassigned alert pool 304.

Groups of analysts may be configured using the administration module 210 in order to define groupings of work for alerts. For example, groups can be configured to work specific types of alerts based on their source such as transaction monitoring system alerts, or fraud system alerts or branch referrals. For another example, groups can be configured to work alerts based on an optimal location for the alerts to be processed. An analyst may be configured to be in zero, one or more than one group.

The background pre-processing routine 306 can be configured to assign alerts to an alert pre-queue 308 for either a group or a specific analyst based on the configured assignment rules. Each pre-queue may have the alerts prioritized based on the configured prioritization rules. An alert review analyst's working queue 310 may be configured to contain a maximum number of alerts to be brought into the analyst's working queue 310 in a batch using the administrative module 210. An alert review analyst 104 interacting with the ARS 200 may use the alert review module 204 to pull the maximum number of alerts from their prioritized analyst pre-queue or one or more prioritized group pre-queues into their own analyst working queue 310.

Using the administrative module 210, a user can setup optional configurable logic to group activity (e.g. alerts) by similar attributes so they can be consolidated and reviewed together. For example, alerts for the same TIN/Customer or the Account Number can be grouped together to optimize the review process by decreasing time and cost.

The administrative module 210 contains a data handler which, through the possibly other software resources or services available, processes new activity reviews in order to assign them to the appropriate pre-queue or workflow step.

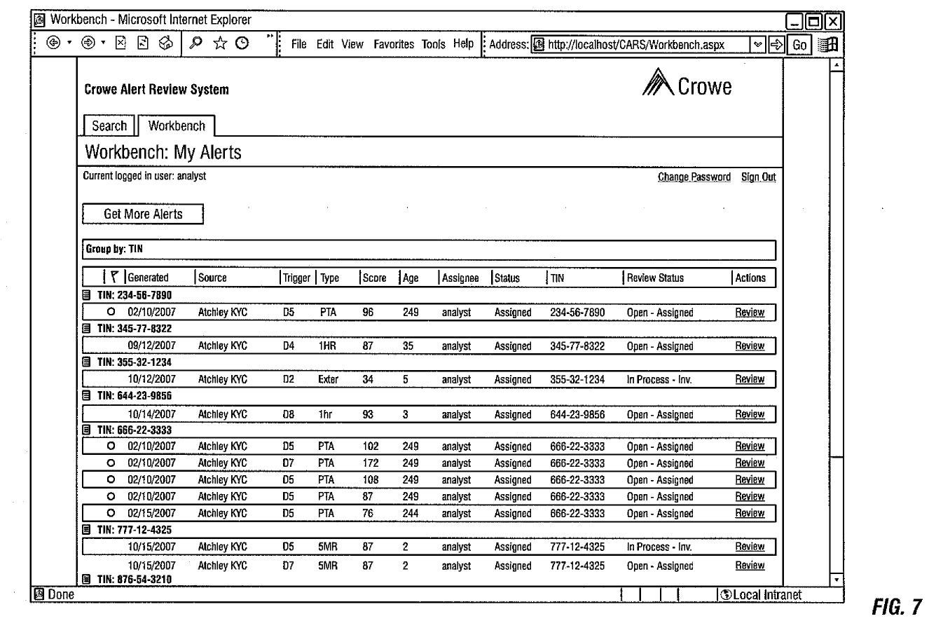

FIG. 7 is provided for illustrative purposes only as an example of a possible interface that could be presented to an analyst 104 for selecting the alerts to be worked from their own working queue 310. In this example, the analyst 104 can view the alerts in any sorted order and also group the alerts based on any of the criteria presented on the analyst's screen. The interface could, in some embodiments, be configured to indicate that certain alerts are past due based an administrator defined parameter configured in the administrative module 210. With this framework and in this embodiment, the analyst 104 can review alerts by clicking on a link to review the alert which then takes the analyst 104 to an alert review module 400. Once the alert review analyst's queue has been depleted, the analyst can request more alerts be brought into the working queue by clicking on the “Get More Alerts” button.

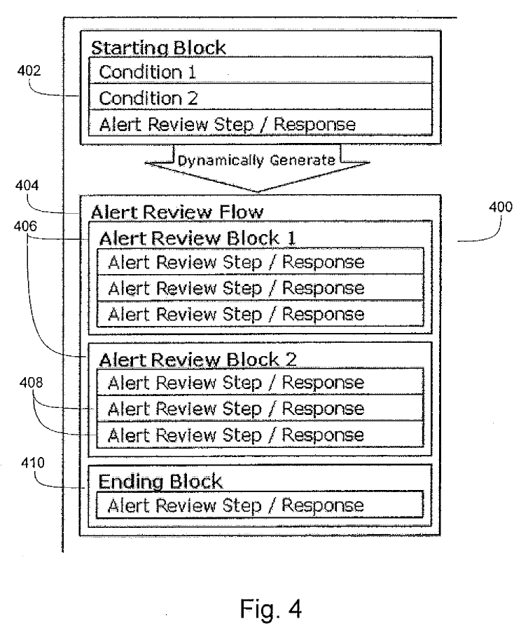

FIG. 4 shows an example of an alert review module 400 which is one component of the ARS 200. The alert review module 400 may be configured with business rules specifying the alert review process for a particular financial institution. For example, the business rules could specify the particular questions to be answered by the analyst 104, possibly including the manner by which the analyst 104 would determine the answer. This will allow an analyst 104 to work through alerts to determine whether a transaction is “not suspicious” and can be dismissed, or, “potentially suspicious” and can be passed to an investigator 106. The business rules instantiated in the alert review module 400 could be configured using the administrative module 210.

A dynamic activity review flow (ARF) 404 that an analyst could follow when reviewing an alert may be based on any data that is either imported into the ARS 200 or entered by an alert review analyst 104 interacting with the ARS 200. The Starting Block 402 may be configured to accept one or more conditions as determinants of the ARF 404 that will be followed by the alert review analyst 104 when reviewing an alert. By way of example only, the starting block 402 may be configured to apply different business logic to review an international wire alert than to review an alert that triggered due to large cash fluctuations in an account. Further, by way of example only, the alert review module 400 may apply different business logic with these alert review blocks so that a high risk personal account is reviewed differently than a low risk personal account. In addition to the conditions that are used to determine the dynamic flow of the alert review, the starting block 402 may contain zero or more alert review steps and their associated responses that apply to every potentially suspicious activity.

A plurality of activity review flows (ARFs) 404 may be configured using the administrative module 210. Each ARF may be configured to consist of multiple Alert Review Blocks (ARBs) 406. An alert review block is a distinct unit of work that analyst would perform as one component of an alert review. By way of example only, reviewing an outgoing international wire alert may include separate and distinct work units including but not limited to:

a) confirm the customer identification

b) review the account relationships

c) perform a Google(R) search on the wire originator and recipient

d) perform a LexisNexis search on the institution's customer

e) document the risk level of the foreign country where the wire is sent

Each of the above work units would be considered an alert review block (ARB) 406. An ARB may be configured to include one or more dynamic alert review steps and associated responses. By way of example only, the work unit a), confirm the customer identification, above, may include alert review steps and recorded responses 408 such as:

i) go to the customer master screen and confirm the customer's name

ii) confirm the customer's tax ID number using ChoicePoint®

iii) enter the customer's form of documentary identification (choices are drivers's license, passport, state ID, matricula card or other)

iv) confirm the customer's documentary identification is current After all dynamically generated ARBs are presented, an ending block 410 may be configured which is common to all alert types.

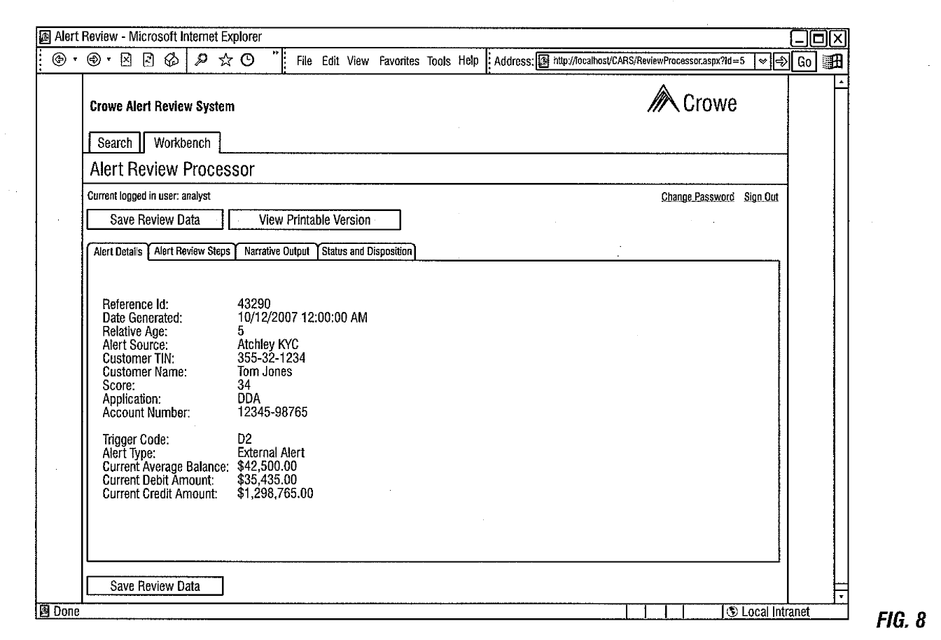

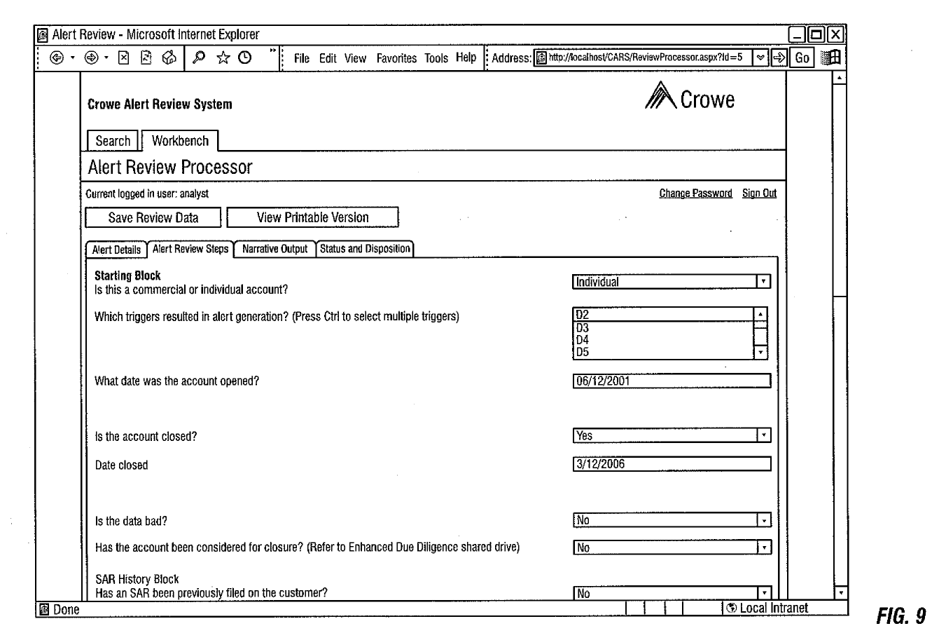

FIG. 8 and FIG. 9 are provided for illustrative purposes only as examples of a possible interface that could be presented to an analyst 104 for proceeding through the business rules of the alert review module 400. In this example, FIG. 8 presents the static information that is available from the alert and FIG. 9 presents the steps an analyst would take by going through a series of predetermined steps and responses. The interface could, in some embodiments, be dynamic to ask different questions depending on the answers provided by the analyst 104. With this framework, which steps the analyst 104 through the information to be gathered, a less experienced analyst 104 could be used. By stepping the analyst 104 through an information gathering and analysis in this manner, subjectivity of the review is reduced. Also, the business rules embed quality control into the analyst's information gathering and decision process.

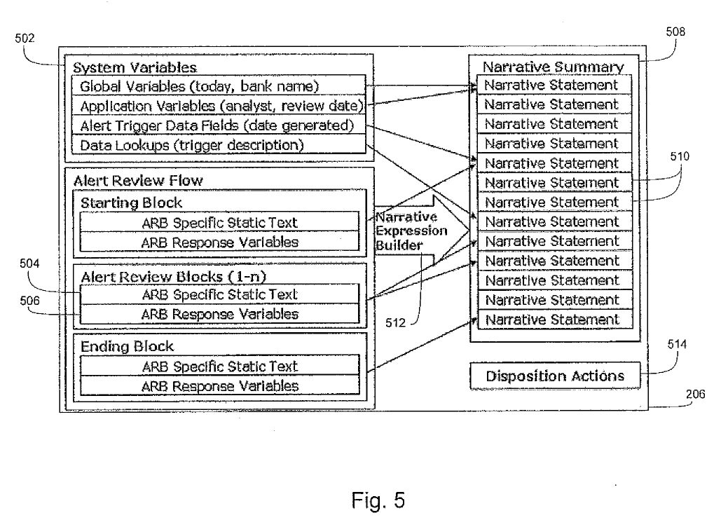

FIG. 5 shows an example narrative engine 206 which is one component of the ARS 200. The narrative engine 206 may be configured to generate a grammatical narrative that combines available system variables with static text and information gathered by an analyst 104 using the alert review module 400. The system variables 502 that are available to the narrative may include, but are not limited to:

a) global variables which, by way of example only, may include today's date, the institutions' full name, a short name for the institution, etc.

b) application variables which, by way of example only, may include the alert review Analyst's name, the review date, the age of the alert, etc.

c) alert trigger data fields which, by way of example only, may include the date the alert was generated, the alert code of the potentially suspicious activity that triggered the event, the parameters tied to the specific trigger, etc.

d) data lookups which, by way of example only, may include the full description of the alert code, the days of the week, product descriptions, etc.

Information is gathered by the alert review analyst through a series of alert review steps and responses 408 as described above. Each step in the alert review blocks (ARB) 406 could include ARB specific static text 504 and ARB response variables 506. The format of the response variables and allowable responses may be configured using the administrative module 210. ARB responses may be configured to be one of several available response types. By way of example only, these response types could be: free text, drop down list, radio button, checkbox, text area, date or numeric. For those responses that are of type numeric, responses may be further formatted through a masking capability so that numeric values are formatted, for example, as tax id numbers, telephone numbers, zip codes, etc.

A narrative summary 508 may be generated by the narrative engine's 206 narrative expression builder 512. Each narrative summary 508 may include one or more narrative statements 510. In one example embodiment of the narrative engine 206, narrative formulas are created and maintained using text string manipulation formulas, Boolean logic and system variables. These variables may be string tokens which can reference either a previously stated answer in the questionnaire or a global value such as the current date. The narrative text formulas may be stored in association with question blocks. When a narrative summary 508 is generated, the narrative expression builder 512 determines all of the blocks used and all of the narratives from those blocks. In this embodiment, the narrative expression builder 512 will create an instance of a built-in expression parser in memory and indicate to the parser all of the possible variables and their answers—if an answer has not been given the parser is told to use the value of “[UNKNOWN]”. The narrative expression builder 512 will then go through each alert review block one by one and extract the formula from the database—once the formula has been loaded it is handed off to a built-in expression parser which first validates that the formula has no syntax errors. It then processes the expression and outputs a value, replacing all of the variables references with the known values for those variables. Depending on various conditions this output is then rendered to the alert review analyst's screen; if there was an error or an unknown value the output is rendered in red and bold text, otherwise standard black.

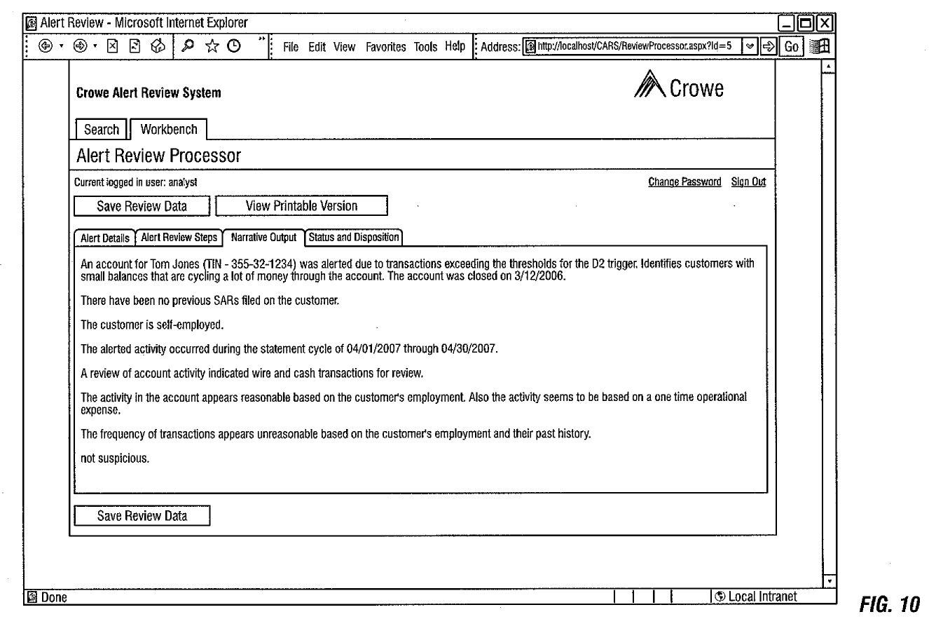

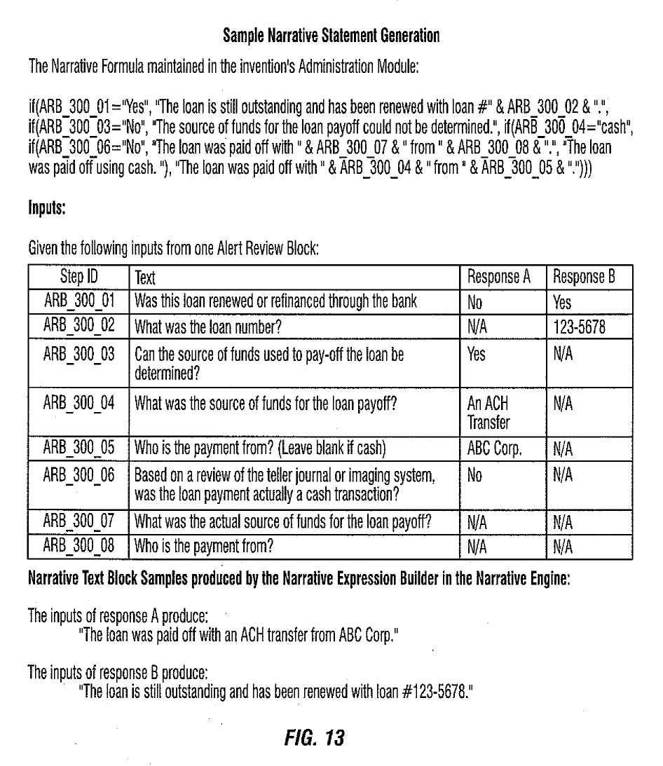

FIG. 10 is provided for illustrative purposes only as an example of a possible interface that could be presented to an analyst showing the generated narrative. For example purposes only, FIG. 13 shows an example of how the narrative engine combines a narrative formula with narrative responses to generate a sample narrative statement.

As a final step to the alert review process, the alert review analyst may indicate the result of the alert review and indicate a disposition action 514. By way of example only, the ARS 200 may provide options to disposition the alert, such as:

a) no further review necessary,

b) escalate/refer to investigator,

c) re-assign to another analyst with high priority,

d) keep the alert in-process, or

e) put the alert on hold (pend) due to, for example, waiting on a request for additional, management directive, supervisory consultation, etc.

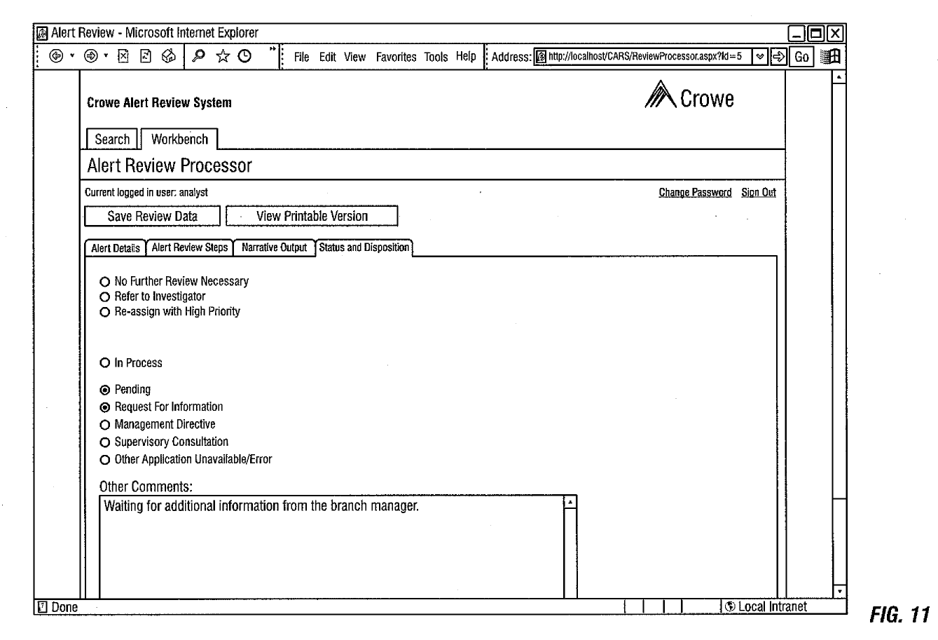

FIG. 11 is provided for illustrative purposes only as an example of a possible interface that could be presented to an analyst for indicating the disposition of a reviewed alert.

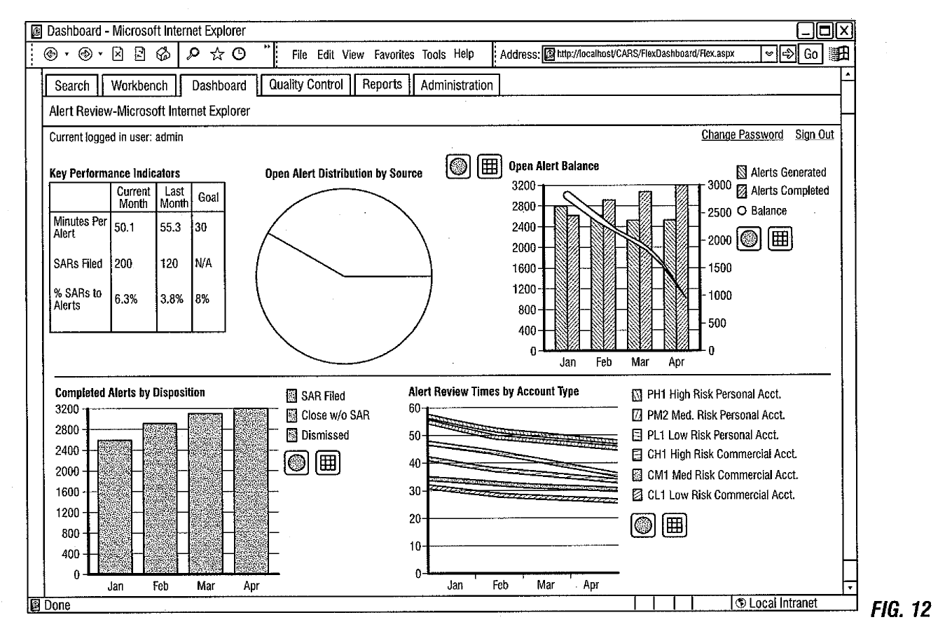

The performance analysis module 208 may be configured to provide an analysis of the alert review and investigative process, including but not limited to an analysis of performance, review times, types of dispositions, distribution of dispositions, number of alerts generated, number of alerts completed and quality of alerts reviewed. If interfaces to external systems are put in place or additional information is manually entered, additional analysis information, such as STRs filed, and alerts closed without filing STRs, can be provided. FIG. 12 provides an example interface that could be provided by the performance analysis module 208.

The performance analysis module 208 contains a dashboard which will let a user select from a variety of configurable graphs and drill down to see more detail. For example, a chart that shows “Numbers of Alerts completed by Analyst” will allow a user to select the bar for each analyst to view how many alerts each had completed status/disposition. The users could then export the chart data to Microsoft Excel.

The administrative module 210 may be configured to perform various administrative functions regarding the ARS 200. By way of example only, the administrative module 210 may be configured to set default parameters, edit system variables, edit alert queue engine rules, edit alert review blocks, edit activity review flows 404, edit alert narrative formulas and import data from external systems.

The administrative module 210 will allow a user to define an ARF 404 at each process stage along the Financial Intelligence Unit (FIU) process 100. A work item to be reviewed is progressed from one stage to the next as work is performed, the appropriate ARF for the given workflow stage is presented. For example, the research stage could have an ARF that detailed the steps needed review the activity, the investigation stage could have an ARF that acts as a dynamic checklist of items needing to be checked, while the quality review stage could contain a different ARF that focuses on the process for validating the review. Various action statuses could be configured and defined for each stage of the FIU process 100 workflow. For example, at the quality review stage, the following action statuses could be defined: “pass—no corrections needed”, “pass—minor corrections”, or “fail—return to analyst”. For each of these statuses, the resulting action can be defined. For example, if the action taken was “fail—return to analyst,” then the resulting stage should be for the work item to be reassigned back to the analyst for further review. A user can configure CARS to load a specific Review Flow for each Workflow stage.

A user can search for information within the ARS 200 by attributes related to activities, groups or workflow stages.

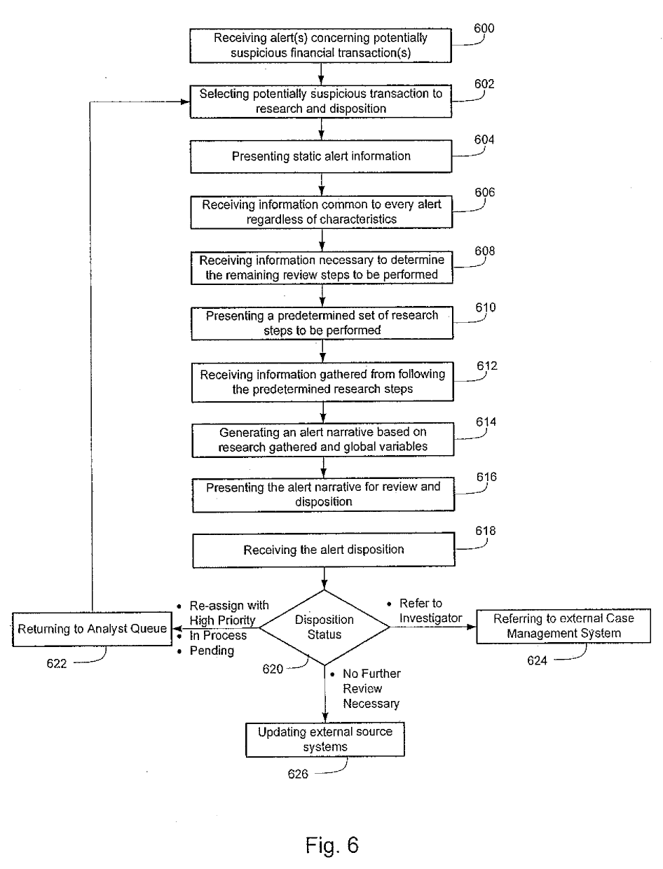

FIG. 6 shows example steps that may be performed by the ARS 200 according to an illustrative embodiment. This illustration presents a flow of how an alert review analyst would interact with the ARS 200 across all modules and engines.

While this disclosure has been described as having an exemplary embodiment, this application is intended to cover any variations, uses, or adaptations using its general principles. It is envisioned that those skilled in the art may devise various modifications and equivalents without departing from the spirit and scope of the disclosure. Further, this application is intended to cover such departures from the present disclosure as may come within the known or customary practice within the art to which it pertains.

What is claimed is:

1. A method for managing the review of potentially suspicious financial transactions, the method comprising the steps of:
providing a plurality of alerts concerning one or more potentially suspicious financial activities;
routing an alert to an anti-money laundering (“AML”) analyst regarding at least one of the unusual activity identifiers over a communication network;
guiding the AML analyst through an automated information gathering process concerning the potentially suspicious financial activity;
generating a report regarding the data collected during the information gathering process;
disposing of the alert if the alert is deemed to not be suspicious by the AML analyst; and
routing the report via the communication network to an AML investigator for investigation if the potentially suspicious activity is deemed to be potentially suspicious by the AML analyst.

2. The method of claim 1, further comprising the step of providing a user interface configured to allow the AML analyst to prioritize the plurality of alerts.

3. The method of claim 2, wherein the plurality of alerts are prioritized based on electronic business rules.

4. The method of claim 2, wherein the interface is configured to indicate an age of an identifier exceeds a predetermined threshold.

5. The method of claim 2, wherein the plurality of alerts are indicative of one or more of transaction monitoring system alerts, transaction monitoring unusual activity reports, large cash activity reports, negative news, bank employee referral, external requests, internal watch lists, triggered account reviews, and fraud alerts.

6. The method of claim 1, wherein at least one of the alerts is provided by a transaction monitoring systems that is configured to detect potentially suspicious transactions.

7. The method of claim 1, wherein the automated information gathering process is based on electronic business rules.

8. The method of claim 7, wherein the electronic business rules apply different business logic depending on the type of alert.

9. The method of claim 7, wherein the electronic business rules include a plurality of activity review flows for one or more of the following types of alerts: an international wire alert, an alert that was triggered due to large cash fluctuations in an account, an alert concerning a high risk personal account, and an alert concerning a low risk personal account.

10. The method of claim 1, wherein the information gather process for a wire-based transfer includes the steps of: (a) confirming a customer identification; (b) performing an web-based search on a wire originator and recipient; and (c) documenting a risk level of a foreign country, if any, where the wire is sent.

11. The method of claim 1, wherein the report comprises an automatically generated grammatical narrative.

12. A system for managing the review of potentially suspicious financial transactions, the system comprising:
an alert queue processing engine configured to manage a plurality of alerts concerning potentially suspicious financial transactions;
an alert review module configured to guide a user through a information gathering process based, at least in part, on one or more characteristics of the suspicious financial transaction; and
a narrative engine configured to generate a grammatical narrative concerning information gathered using the alert review module.

13. The system of claim 12, wherein the alert queue processing engine is configured to prioritize alerts based on electronic business rules.

14. The system of claim 13, wherein the alert queue processing engine is configured to translate unprioritized alerts into a prioritized order in which alerts are to be handled.

15. The system of claim 14, wherein the alert queue processing engine is configured to assign alerts to a user who is assigned to handle the alert.

16. The system of claim 12, wherein the narrative engine is configured to combine one or more system variables with information gathered via the alert review module into a grammatical narrative.

17. The system of claim 16, wherein the system variables comprises one or more of global variables, application variables, alert trigger data fields, and data lookups.

18. The system of claim 16, wherein the system variables includes a date an alert was generated.

19. The system of claim 16, wherein the system variables includes an alert code of the potentially suspicious activity that triggered the alert.

20. The system of claim 16, wherein the narrative engine is configured to include predetermined, static text in the grammatical narrative.

21. The system of claim 12, further comprising a performance analysis module configured to provide an analysis of the review process.

22. The system of claim 21, wherein the performance analysis module is configured to provide one or more metrics regarding the review of alerts, including one or more of an analysis of performance, review times, types of dispositions, distribution of dispositions, number of alerts generated, number of alerts completed and quality of alerts reviewed.

23. The system of claim 22, wherein the metrics are provided substantially in real time.

24. The system of claim 23, wherein the performance analysis module includes a dashboard configured to present one or more graphical representations of the metrics.

25. The system of claim 12, further comprising an administrative module configured to provide an interface for re-assigning alerts within the alert queue processing engine.

26. The system of claim 12, further comprising an administrative module configured to provide an interface for re-prioritizing alerts within the alert queue processing engine.

27. The system of claim 12, further comprising an administrative module including an activity generation wizard configured to allow application of rules against a set of data in order to produce new activity for review.

28. The system of claim 12, further comprising an administrative module configured to group particular types of alerts for assignment to a group of users.

29. The system of claim 28, wherein the alerts are grouped based on source.

30. A computer-readable medium having computer-executable instructions for performing a method comprising the steps of:
receiving a plurality of potentially unusual financial activity alerts;
presenting a plurality of information gathering steps to be performed by a user, wherein the information gathering steps are based, at least in part, on characteristics of a suspicious financial transaction;
storing information gathered from following the information gathering steps;
automatically generating an alert narrative based on the information gathered, wherein the alert narrative comprises one or more grammatical sentences; and
presenting the alert narrative to a user for review and disposition.
